(19) United States
(12) Patent Application Publication
(10) Pub. No.: US 2008/0281990 A1
(43) Pub. Date: Nov. 13, 2008

(54) Expansion device adapted for use with a portable electronic device

(75) Inventor: Min-Chuan Wan, Hsinchu City (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: XGI Technology Inc., Hsinchu City (TW)

(21) Appl. No.: 11/892,212

(22) Filed: Aug. 21, 2007

(30) Foreign Application Priority Data
May 7, 2007 (TW) 096116106

(51) Int. Cl. G06F 3/00

(52) U.S. Cl. 710/2

(57) ABSTRACT

An expansion device includes an adapter unit connected electrically to an Express card connector and a television signal receiving unit such that television audio-video data obtained by processing an external television signal by the television signal receiving unit is transmitted to a portable electronic device via the adapter unit and the Express card connector, an audio coder/decoder unit connected electrically to the adapter unit for receiving and processing an audio output from the portable electronic device via the Express card connector and the adapter unit and for providing the processed audio output to an external speaker unit for reproduction, and a graphics processing unit for receiving a video output from the portable electronic device via the Express card connector and for providing processed video output to an external display unit for display.

### CROSS-REFERENCE TO RELATED APPLICATION

This application claims priority of Taiwanese Application No. 096116106, filed on May 7, 2007.

### BACKGROUND OF THE INVENTION

1. Field of the Invention

The invention relates to an expansion device, more particularly to an expansion device adapted for use with a portable electronic device.

2. Description of the Related Art

Referring to FIG. 1, a conventional expansion device 20 for use with a notebook computer 22 is shown to include a connecting port expansion circuit 25 connected electrically to a first wireless transmission module 24, and at least one of various external devices 21, such as a keyboard, a mouse, a liquid crystal display, a hard drive, etc., a connector 26 connected electrically to the connecting port expansion circuit 25, a USB interface 28 connected electrically to the connector 26, a television (TV) receiver 27 connected electrically to the USB interface 28, and a second wireless transmission module 29 connected electrically to the TV receiver 27.

An input signal from the external device 21 is received by the connecting port expansion circuit 25, and is transmitted to the notebook computer 22 via the connector 26 when the connector 26 is connected electrically and wiredly to the notebook computer 22 or via the first wireless transmission module 24 when the first wireless transmission module 24 is connected electrically and wirelessly to the notebook computer 22. On the other hand, an input signal from the notebook computer 22 can be received by the connector 26 or the first wireless transmission module 24, and is transmitted to the external device 21 via the connecting port expansion circuit 25.

In addition, an external TV signal is received by the TV receiver 27 via the second wireless transmission module 29, and is transmitted to the notebook computer 22 via the USB interface 28 and the connector 26 when the connector 26 is connected electrically and wiredly to the notebook computer 22 or via the USB interface 28, the connector 26, the connecting port expansion circuit 25 and the first wireless transmission module 24 when the connector 26 is disconnected from the notebook computer 22. On the other hand, a control signal from the notebook computer 22 can be sent to the TV receiver 27 via the second wireless transmission module 29 or the connector 26 and the USB interface 28.

In such a configuration, since the connecting port expansion circuit 25 is a so-called port duplicator, which has the same connecting port specifications as those of the notebook computer 22 to facilitate connection between the notebook computer 22 and the external device 21 through the expansion device 20, the conventional expansion device 20 is not suitable for other notebook computers having connecting port specifications different from those of the connecting port expansion circuit 25 while a display acting as the external device 21 can display a video signal received from the notebook computer 22 via the conventional expansion device 20, and a speaker acting as the external device 21 can reproduce an audio signal received from the notebook computer 22 via the conventional expansion device 20, the video shown by the display and the audio reproduced by the speaker cannot be different from video shown on the notebook computer 22 and audio reproduced by the notebook computer 22.

### SUMMARY OF THE INVENTION

Therefore, the object of the present invention is to provide an expansion device that can overcome the aforesaid drawbacks of the prior art.

According to the present invention, there is provided an expansion device adapted for use with a portable electronic device. The expansion device comprises:

a television signal receiving unit adapted for receiving and processing an external television signal and for outputting television audio-video data corresponding to the external television signal;

an Express card connector adapted to be connected electrically to the portable electronic device;

an adapter unit connected electrically to the Express card connector and the television signal receiving unit such that the television audio-video data from the television signal receiving unit is transmitted to the portable electronic device via the adapter unit and the Express card connector;

an audio coder/decoder unit connected electrically to the adapter unit and adapted to be connected electrically to an external speaker unit for receiving and processing an audio output from the portable electronic device via the Express card connector and the adapter unit and for providing the processed audio output to the external speaker unit for reproduction; and

a graphics processing unit adapted to be connected electrically to an external display unit, and adapted for receiving and processing a video output from the portable electronic device via the Express card connector and for providing the processed video output to the external display unit for display.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit block diagram illustrating a conventional expansion device;

FIG. 2 is a schematic circuit block diagram illustrating the first preferred embodiment of an expansion device according to the present invention;

FIG. 3 is a schematic circuit block diagram illustrating the second preferred embodiment of an expansion device according to the present invention;

FIG. 4 is a schematic circuit block diagram illustrating the third preferred embodiment of an expansion device according to the present invention;

FIG. 5 is a schematic circuit block diagram illustrating the fourth preferred embodiment of an expansion device according to the present invention;

FIG. 6 is a schematic circuit block diagram illustrating the fifth preferred embodiment of an expansion device according to the present invention;

FIG. 7 is a schematic circuit block diagram illustrating the sixth preferred embodiment of an expansion device according to the present invention;

FIG. 8 is a schematic circuit block diagram illustrating the seventh preferred embodiment of an expansion device according to the present invention;

FIG. 9 is a schematic circuit block diagram illustrating the eighth preferred embodiment of an expansion device according to the present invention; and

FIG. 10 is a schematic circuit block diagram illustrating the ninth preferred embodiment of an expansion device according to the present invention.

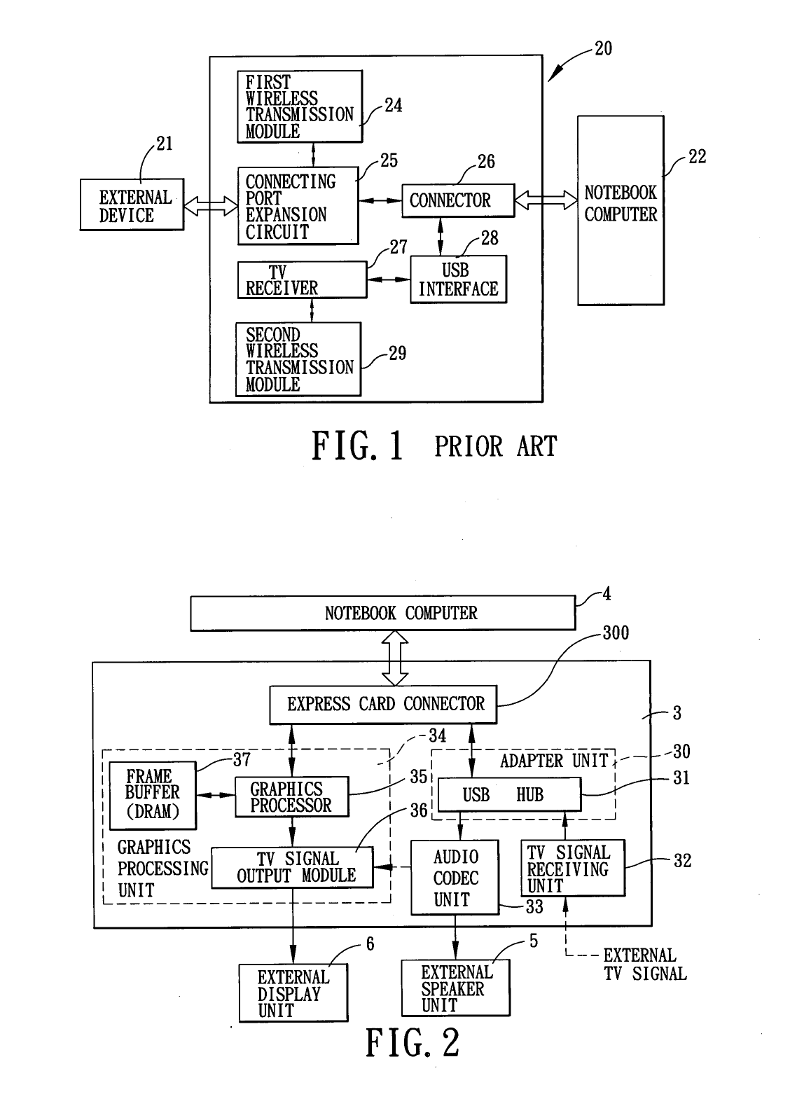

### DETAILED DESCRIPTION OF THE PREFERRED EMBODIMENTS

Before the present invention is described in greater detail, it should be noted that like elements are denoted by the same reference numerals throughout the disclosure.

Referring to FIG. 2, the preferred embodiment of an expansion device 3 according to the present invention is shown to be adapted for use with a portable electronic device. In this embodiment, the portable electronic device is a notebook computer 4. The expansion device 3 includes a television (TV) signal receiving unit 32, an Express card connector 300, an adapter unit 30, an audio coder/decoder (codec) unit 33, and a graphics processing unit 34.

The Express card connector 300 is adapted to be connected electrically to the notebook computer 4. In this embodiment, the Express card connector 300 has a PCI Express interface, and also supports a USB interface.

The adapter unit 30 is connected electrically to the Express card connector 300. In this embodiment, the adapter unit 30 includes a USB hub 31 that is connected electrically to the Express card connector 300 and that has a plurality of connecting ports (not shown) adapted to be connected electrically and respectively with various external devices (not shown), such as a mouse, a printer, a local area network device, a keyboard, etc. Hence, when the Express card connector 300 is connected electrically to the notebook computer 4, the notebook computer 4 can be connected electrically to the external devices via the Express card connector 300 and the USB hub 31.

In this embodiment, the TV signal receiving unit 32 has a USB interface, is connected electrically to the USB hub 31 of the adapter unit 30, and is adapted for receiving an external TV signal. The TV signal receiving unit 32 includes at least one of an analog TV signal receiver and a digital TV signal receiver. When the external TV signal is an analog TV signal, the TV signal receiving unit 32 performs digitization and decoding operations for the analog TV signal after tuning of the analog TV signal by a tuner (not shown) so as to output TV audio-video data corresponding to the analog TV signal. On the other hand, when the external TV signal is a digital TV signal, the TV signal receiving unit 32 outputs TV audio-video data corresponding to the digital TV signal after processing. Hence, the TV audio-video data from the TV signal receiving unit 32 is transmitted to the notebook computer 4 through the USB hub 31 and the Express card connector 300. As a result, the notebook computer 4 can be configured to receive TV programs utilizing the expansion device 3.

In this embodiment, the audio codec unit 33 has a USB interface, is connected electrically to the USB hub 31 of the adapter unit 30, and is adapted to be connected electrically to an external speaker unit 5 for receiving and processing an audio output from the notebook computer 4 via the Express card connector 300 and the USB hub and for providing the processed audio output to the external speaker unit 5 for reproduction.

The graphics processing unit 34 includes a graphics processor 35, a frame buffer 37 and a TV signal output module 36. In this embodiment, the graphics processor has a PCI Express interface, is connected electrically to the Express card connector 300, and is adapted for receiving and processing a video output from the notebook computer 4 via the Express card connector 300 and for generating the processed video output in an image frame format. The frame buffer 37, such as a DRAM, is connected electrically to the graphics processor 35 for storing the processed video output therefrom. The TV signal output module 36 is connected electrically to the graphics processor 35, and is adapted to be connected electrically to an external display unit 6 for outputting the processed video output to the external display unit 6 for display. In this embodiment, the TV signal output module 36 includes a TV encoder (not shown) having at least one of a composite output, a S-video output and a component output for encoding the processed video output to have a video specification corresponding to the at least one of the composite output, the S-video output and the component output.

In other embodiments, when the external display unit 6 supports high-definition multimedia interface (HDMI), the TV signal output module 36 can be a DVI/HDMI transmitter (not shown). In this case, the audio codec unit 33 is connected selectively and electrically to the DVI/HDMI transmitter such that the DVI/HDMI transmitter receives and integrates the processed audio output from the audio codec unit 32 and the processed video output from the graphics processor 35 to output a HDMI signal to the external display unit 6.

Alternatively, when the audio codec unit 33 is disconnected from the DVI/HDMI transmitter, the DVI/HDMI transmitter receives the processed video output to output a DVI signal to the external display unit 6.

Additionally, in other embodiments, the graphics processor 35 and the TV signal output module 36 can be integrated into a single chip.

In such a configuration, due to the presence of the graphics processing unit 34 and the audio codec unit 33, the expansion device 3 of this invention can process audio-video data different from that reproduced or displayed by the notebook computer 4. For example, while the notebook computer 4 is used for internet access, processing documents or playing games, the notebook computer 4 can utilize the expansion device 3 to receive the external TV signal and to provide respectively the processed audio and video outputs corresponding to the external TV signal to the external speaker unit 5 and the external display unit 6.

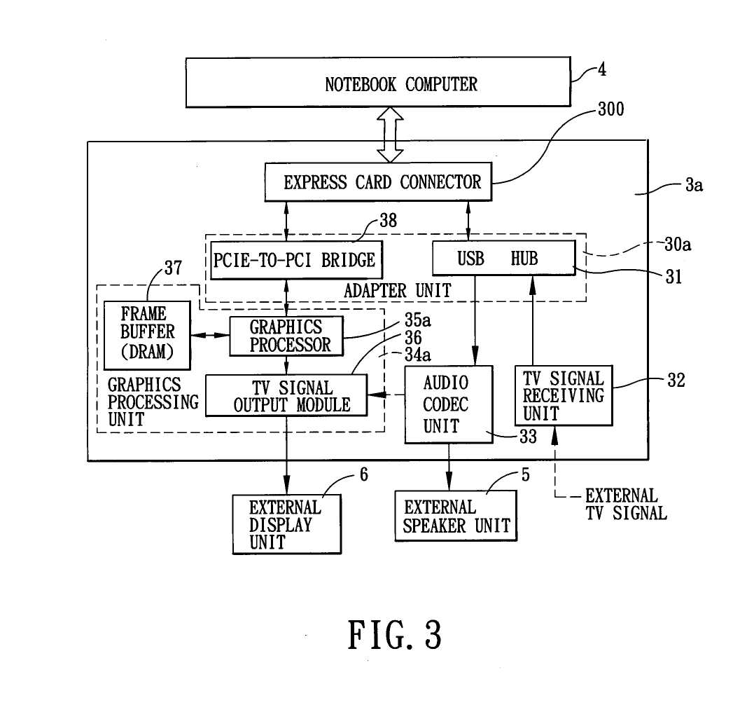

FIG. 3 illustrates the second preferred embodiment of an expansion device (3a) according to this invention, which is a modification of the first preferred embodiment. In this embodiment, the graphics processor (35a) of the graphics processing unit (34a) has a PCI interface. The adapter unit (30a) further includes a PCIE-to-PCI bridge 38 interconnecting electrically the Express card connector 300 and the graphics processor (35a) of the graphics processing unit (34a) such that the graphics processor (35a) of the graphics processing unit (34a) is adapted to receive the video output from the notebook computer 4 via the Express card connector 300 and the PCIE-to-PCI bridge 38.

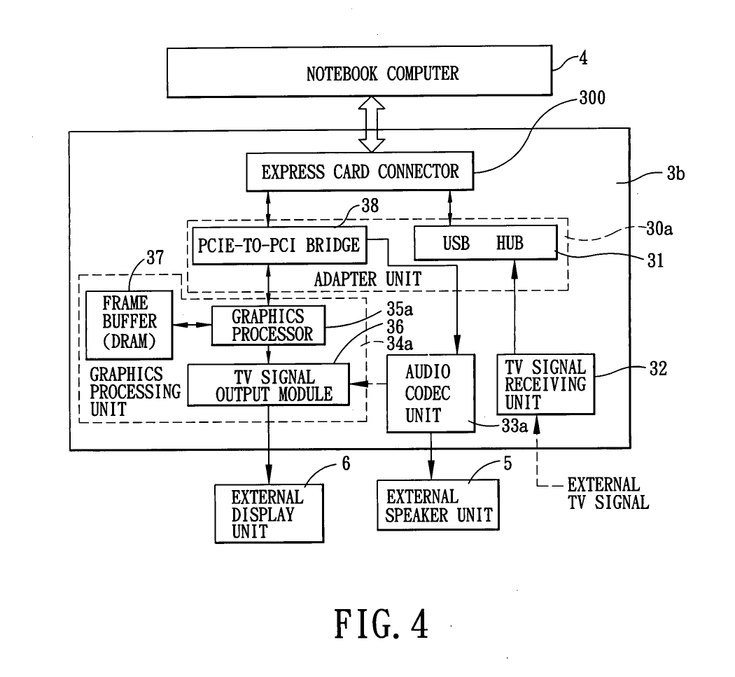

FIG. 4 illustrates the third preferred embodiment of an expansion device (3b) according to this invention, which is a modification of the second preferred embodiment. Unlike the second preferred embodiment, the audio codec unit (33a) has a PCI interface, and is connected electrically to the PCIE-to-PCI bridge 38 of the adapter unit (30a) such that the audio coder/decoder unit (33a) is adapted to receive the audio output from the notebook computer 4 via the Express card connector 300 and the PCIE-to-PCI bridge 38.

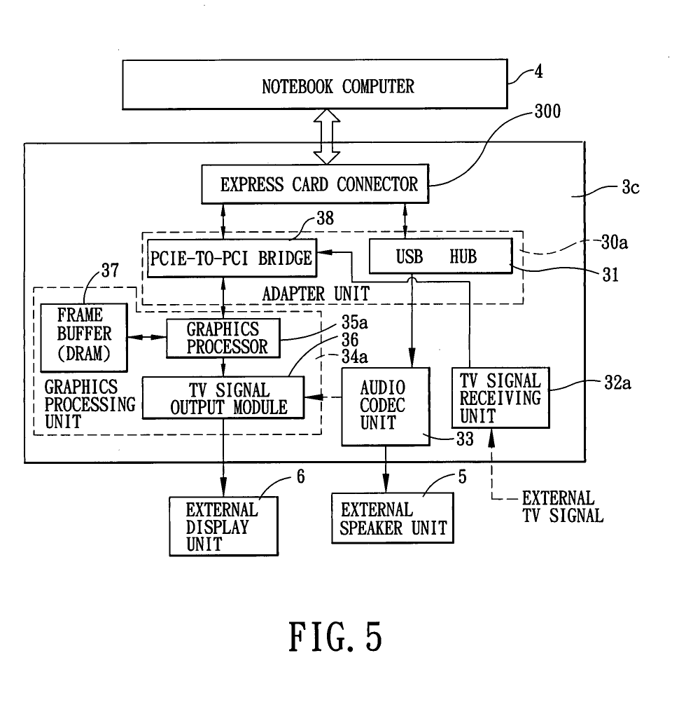

FIG. 5 illustrates the fourth preferred embodiment of an expansion device (3c) according to this invention, which is a modification of the second preferred embodiment. Unlike the second preferred embodiment, the TV signal receiving unit (32a) has a PCI interface, and is connected electrically to the PCIE-to-PCI bridge 38 of the adapter unit (30a) such that the television audio-video data from the TV signal receiving unit (32a) is transmitted to the notebook computer 4 via the Express card connector 300 and the PCIE-to-PCI bridge 38.

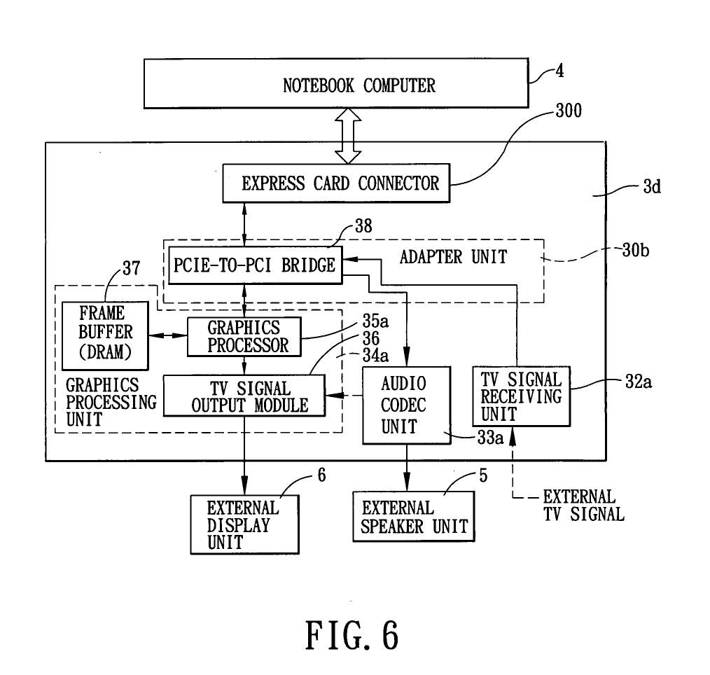

FIG. 6 illustrates the fifth preferred embodiment of an expansion device (3d) according to this invention, which is a modification of the second preferred embodiment. Unlike the second preferred embodiment, the adapter unit (30b) includes merely the PCIE-to-PCI bridge 38. Each of the TV signal receiving unit (32a) and the audio codec unit (33a) has a PCI interface, and is connected electrically to the PCIE-to-PCI bridge 38 of the adapter unit (30b) such that the television audio-video data from the TV signal receiving unit (32a) is transmitted to the notebook computer 4 via the Express card connector 300 and the PCIE-to-PCI bridge 38, and that the audio codec unit (33a) is adapted to receive the audio output from the notebook computer 4 via the Express card connector 300 and the PCIE-to-PCI bridge 38.

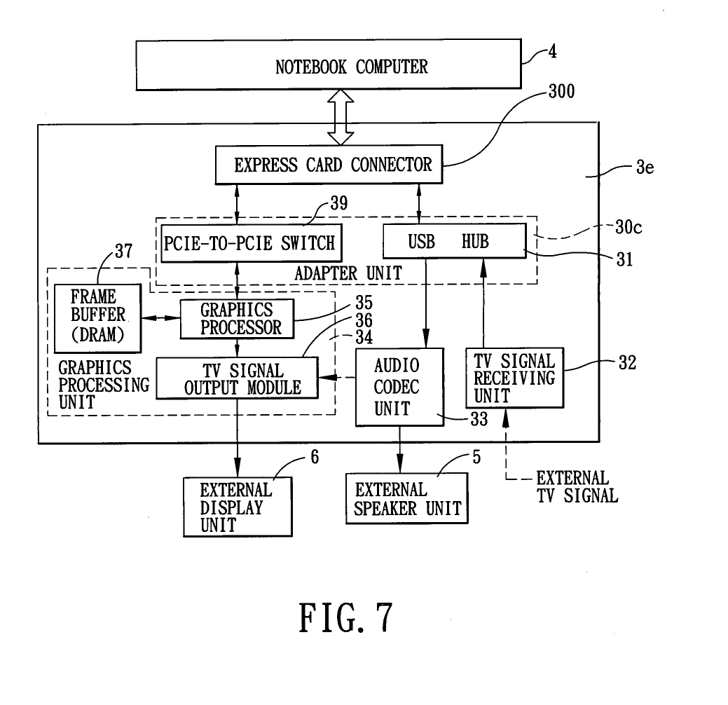

FIG. 7 illustrates the sixth preferred embodiment of an expansion device (3e) according to this invention, which is a modification of the first preferred embodiment. In this embodiment, the adapter unit (30c) further includes a PCIE-to-PCIE switch 39 interconnecting electrically the Express card connector 300 and the graphics processor 35 of the graphics processing unit 34 such that the graphics processor 35 of the graphics processing unit 34 is adapted to receive the video output from the notebook computer 4 via the Express card connector 300 and the PCIE-to-PCIE switch 39.

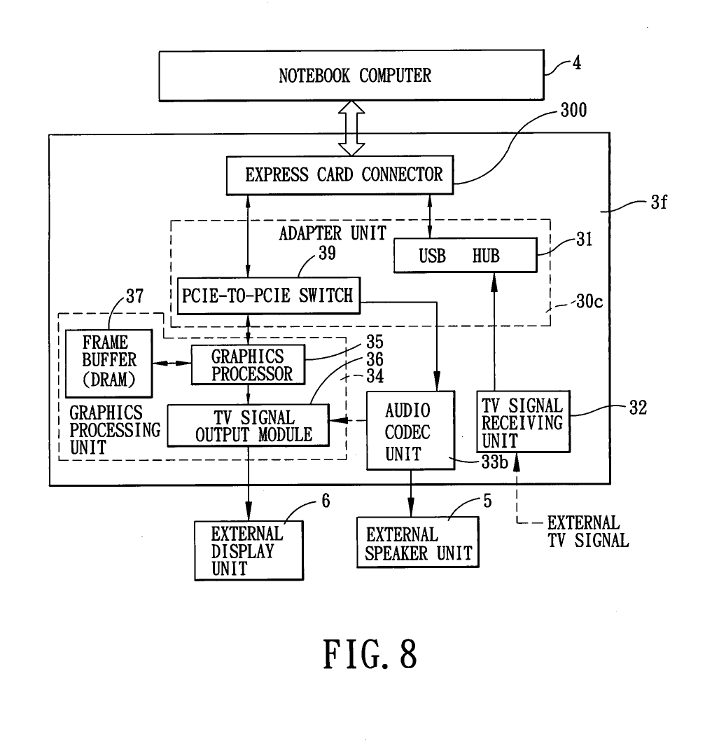

FIG. 8 illustrates the seventh preferred embodiment of an expansion device (3f) according to this invention, which is a modification of the sixth preferred embodiment. Unlike the sixth preferred embodiment, the audio codec unit (33b) has a PCIE interface, and is connected electrically to the PCIE-to-PCIE switch 39 of the adapter unit (30c) such that the audio codec unit (33a) is adapted to receive the audio output from the notebook computer 4 via the Express card connector 300 and the PCIE-to-PCIE switch 39.

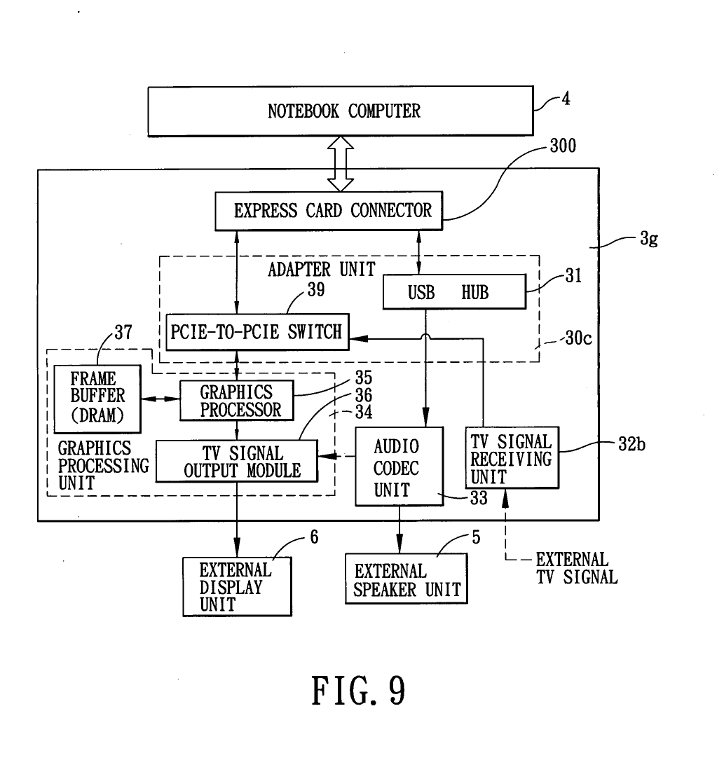

FIG. 9 illustrates the eighth preferred embodiment of an expansion device (3g) according to this invention, which is a modification of the sixth preferred embodiment. Unlike the sixth preferred embodiment, the TV signal receiving unit (32b) has a PCIE interface, and is connected electrically to the PCIE-to-PCIE switch 39 of the adapter unit (30c) such that the television audio-video data from the TV signal receiving unit (32b) is transmitted to the notebook computer 4 via the Express card connector 300 and the PCIE-to-PCIE switch 39.

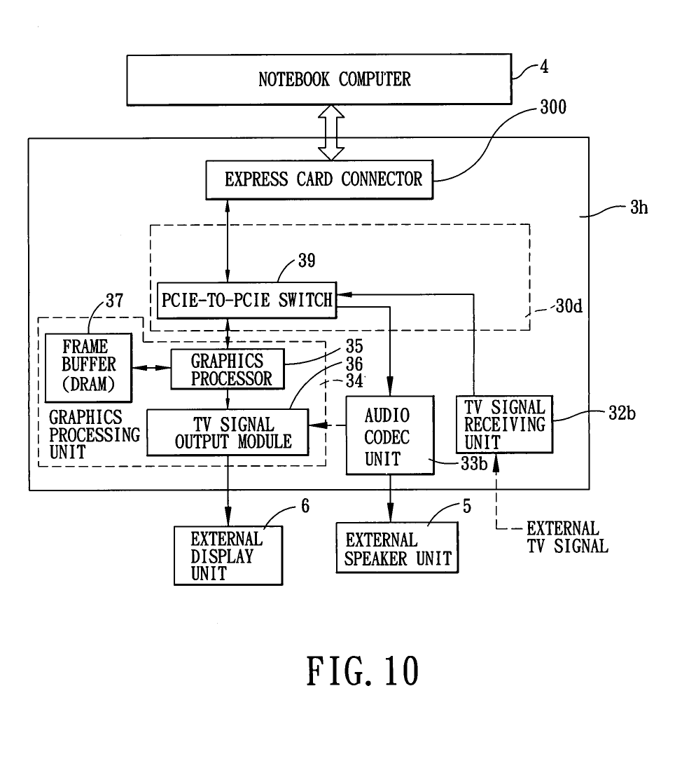

FIG. 10 illustrates the ninth preferred embodiment of an expansion device (3h) according to this invention, which is a modification of the sixth preferred embodiment. Unlike the sixth preferred embodiment, the adapter unit (30d) includes merely the PCIE-to-PCIE switch 39. Each of the TV signal receiving unit (32b) and the audio codec unit (33b) has a PCIE interface, and is connected electrically to the PCIE-to-PCIE switch 39 of the adapter unit (30d) such that the television audio-video data from the TV signal receiving unit (32b) is transmitted to the notebook computer 4 via the Express card connector 300 and the PCIE-to-PCIE switch 39, and that the audio codec unit (33b) is adapted to receive the audio output from the notebook computer 4 via the Express card connector 300 and the PCIE-to-PCIE switch 39.

In sum, the expansion device 3, (3a), (3b), (3c), (3d), (3e), (3f), (3g), (3h) of this invention is adapted for use with any portable electronic device having an Express card interface. Moreover, due to the presence of the graphics processing unit 34, (34a) and the audio codec unit 33, (33a), (33b), the expansion device 3, (3a), (3b), (3c), (3d), (3e), (3f), (3g), (3h) of this invention can provide respectively the processed audio and video outputs corresponding to the external TV signal to the external speaker unit 5 and the external display unit 6 for presentation.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An expansion device adapted for use with a portable electronic device, comprising:
a television signal receiving unit adapted for receiving and processing an external television signal and for outputting television audio-video data corresponding to the external television signal;
an Express card connector adapted to be connected electrically to the portable electronic device;
an adapter unit connected electrically to said Express card connector and said television signal receiving unit such that the television audio-video data from said television signal receiving unit is transmitted to the portable electronic device via said adapter unit and said Express card connector;
an audio coder/decoder unit connected electrically to said adapter unit and adapted to be connected electrically to an external speaker unit for receiving and processing an audio output from the portable electronic device via said Express card connector and said adapter unit and for providing the processed audio output to the external speaker unit for reproduction; and
a graphics processing unit adapted to be connected electrically to an external display unit, and adapted for receiving and processing a video output from the portable electronic device via said Express card connector and for providing the processed video output to the external display unit for display.

2. The expansion device as claimed in claim 1, wherein said Express card connector has a PCI Express interface.

3. The expansion device as claimed in claim 2, wherein:
each of said audio coder/decoder unit and said television signal receiving unit has a USB interface;
said adapter unit includes a USB hub interconnecting electrically said Express card connector, said television signal receiving unit and said audio codec unit; and
said graphics processing unit has a PCI Express interface, and is connected electrically to said Express card connector.

4. The expansion device as claimed in claim 2, wherein:
each of said audio coder/decoder unit and said television signal receiving unit has a USB interface;
said graphics processing unit has a PCI interface; and
said adapter unit includes a USB hub interconnecting electrically said Express card connector, said television signal receiving unit and said audio coder/decoder unit, and a PCIE-to-PCI bridge interconnecting electrically said Express card connector and said graphics processing unit such that said graphics processing unit is adapted to receive the video output from the portable electronic device via said Express card connector and said PCIE-to-PCI bridge.

5. The expansion device as claimed in claim 2, wherein:
said television signal receiving unit has a USB interface;
each of said graphics processing unit and said audio coder/decoder unit has a PCI interface; and
said adapter unit includes a USB hub interconnecting electrically said Express card connector and said television signal receiving unit, and a PCIE-to-PCI bridge interconnecting electrically said Express card connector, said graphics processing unit and said audio coder/decoder unit such that said graphics processing unit is adapted to receive the video output from the portable electronic device via said Express card connector and said PCIE-to-PCI bridge, and that said audio coder/decoder unit is adapted to receive the audio output from the portable electronic device via said Express card connector and said PCIE-to-PCI bridge.

6. The expansion device as claimed in claim 2, wherein:
said audio coder/decoder unit has a USB interface;
each of said graphics processing unit and said television signal receiving unit has a PCI interface; and
said adapter unit includes a USB hub interconnecting electrically said Express card connector and said audio coder/decoder unit, and a PCIE-to-PCI bridge interconnecting electrically said Express card connector, said graphics processing unit and said television signal receiving unit such that said graphics processing unit is adapted to receive the video output from the portable electronic device via said Express card connector and said PCIE-to-PCI bridge, and that the television audio-video data from said TV signal receiving unit is transmitted to the portable electronic device via said Express card connector and said PCIE-to-PCI bridge.

7. The expansion device as claimed in claim 2, wherein:
each of said television signal receiving unit, said audio coder/decoder unit and said graphics processing unit has a PCI interface; and
said adapter unit includes a PCIE-to-PCI bridge interconnecting electrically said television signal receiving unit, said audio coder/decoder unit, said graphics processing unit and said Express card connector such that said graphics processing unit is adapted to receive the video output from the portable electronic device via said Express card connector and said PCIE-to-PCI bridge, that said audio coder/decoder unit is adapted to receive the audio output from the portable electronic device via said Express card connector and said PCIE-to-PCI bridge, and that the television audio-video data from said television signal receiving unit is transmitted to the portable electronic device via said Express card connector and said PCIE-to-PCI bridge.

8. The expansion device as claimed in claim 2, wherein:
each of said audio coder/decoder unit and said television signal receiving unit has a USB interface;
said graphics processing unit has a PCIE Express interface; and
said adapter unit includes a USB hub interconnecting electrically said Express card connector, said television signal receiving unit and said audio coder/decoder unit, and a PCIE-to-PCIE switch interconnecting electrically said Express card connector and said graphics processing unit such that said graphics processing unit is adapted to receive the video output from the portable electronic device via said Express card connector and said PCIE-to-PCIE switch.

9. The expansion device as claimed in claim 2, wherein:
said television signal receiving unit has a USB interface;
each of said graphics processing unit and said audio coder/decoder unit has a PCIE interface; and
said adapter unit includes a USB hub interconnecting electrically said Express card connector and said television signal receiving unit, and a PCIE-to-PCIE switch interconnecting electrically said Express card connector, said graphics processing unit and said audio coder/decoder unit such that said graphics processing unit is adapted to receive the video output from the portable electronic device via said Express card connector and said PCIE-to-PCIE switch, and that said audio coder/decoder unit is adapted to receive the audio output from the portable electronic device via said Express card connector and said PCIE-to-PCIE switch.

10. The expansion device as claimed in claim 2, wherein:
said audio coder/decoder unit has a USB interface;
each of said graphics processing unit and said television signal receiving unit has a PCIE interface; and
said adapter unit includes a USB hub interconnecting electrically said Express card connector and said audio coder/decoder unit, and a PCIE-to-PCIE switch interconnecting electrically said Express card connector, said graphics processing unit and said television signal receiving unit such that said graphics processing unit is adapted to receive the video output from the portable electronic device via said Express card connector and said PCIE-to-PCIE switch, and that the television audio-video data from said television signal receiving unit is transmitted to the portable electronic device via said Express card connector and said PCIE-to-PCIE switch.

11. The expansion device as claimed in claim 2, wherein:
each of said television signal receiving unit, said audio coder/decoder unit and said graphics processing unit has a PCIE interface; and
said adapter unit includes a PCIE-to-PCIE switch interconnecting electrically said television signal receiving unit, said audio coder/decoder unit, said graphics processing unit and said Express card connector such that said graphics processing unit is adapted to receive the video output from the portable electronic device via said Express card connector and said PCIE-to-PCIE switch, that said audio coder/decoder unit is adapted to receive the audio output from the portable electronic device via said Express card connector and said PCIE-to-PCIE switch, and that the television audio-video data from said television signal receiving unit is transmitted to the portable electronic device via said Express card connector and said PCIE-to-PCIE switch.

12. The expansion device as claimed in claim 1, wherein said graphics processing unit includes:
a graphics processor adapted for receiving and processing the video output from the portable electronic device;
a frame buffer connected electrically to said graphics processor for storing the processed video output therefrom; and
a television signal output module connected electrically to said graphics processor and adapted to be connected electrically to the external display unit.

13. The expansion device as claimed in claim 12, wherein said television signal output module includes a TV encoder having a composite output.

14. The expansion device as claimed in claim 12, wherein said television signal output module includes a TV encoder having a S-video output.

15. The expansion device as claimed in claim 12, wherein said television signal output module includes a TV encoder having a component output.

16. The expansion device as claimed in claim 12, wherein said television signal output module includes a DVI/HDMI transmitter connected selectively and electrically to said audio coder/decoder unit for receiving the processed audio output therefrom.

17. The expansion device as claimed in claim 1, wherein said television signal receiving unit includes an analog television signal receiver.

18. The expansion device as claimed in claim 1, wherein said television signal receiving unit includes a digital television signal receiver.
